(19) United States
(12) Patent Application Publication
(10) Pub. No.: US 2008/0284289 A1
(43) Pub. Date: Nov. 20, 2008

(54) SPACE-SUIT MATABLE ENCLOSURE PROVIDING WORKSPACE FOR ASTRONAUTS

(75) Inventor: Gary FISHER, Huntington Valley, PA (US)

Correspondence Address: Saul Ewing LLP (Philadelphia), Attn: Patent Docket Clerk, 2 North Second St., Harrisburg, PA, 17101, US

(73) Assignee: LIFT-OFF TECHNOLOGIES CORPORATION, Huntington Valley, PA (US)

(21) Appl. No.: 12/120,602

(22) Filed: May 14, 2008

Related U.S. Application Data
(60) Provisional application No. 60/917,954, filed on May 15, 2007.

(51) Int. Cl. B25J 21/00

(52) U.S. Cl. 312/1

(57) ABSTRACT

An enclosure providing a workspace for astronauts, deep-sea divers, etc. wearing pressurized suits includes a housing providing a substantially-closed chamber, a port providing access to the chamber, and a connector circumscribing the port. The enclosure's connector is configured to mate with, and form an airtight seal with, a complementary connector of the suit to close the chamber. A pressure control system may be provided to pressurize and depressurize the chamber. After connecting the enclosure to the suit, the closed chamber may be pressurized to balance pressures internal and external to the suit to facilitate manual operations. Any mated connectors of suit portions internal to the enclosure may be decoupled to expose a human limb, etc., and yet the pressure in the chamber may be maintained. The suit may include a limb-engaging seal resisting intermixing of chamber gases with suit gases while matable connectors of the suit are decoupled.

### CROSS-REFERENCE TO RELATED APPLICATION

This application claims the benefit of U.S. Provisional Patent Application No. 60/917,954, filed May 15, 2007, the entire disclosure of which is hereby incorporated herein by reference.

### FIELD OF THE INVENTION

The present invention relates generally to space suits for astronauts, and more particularly to a space-suit matable enclosure that effectively extends the controlled internal environment of a pressurized space suit, and thus provides a controlled environment workspace in which astronauts can work with gloves or other portions of a space suit removed.

### BACKGROUND OF THE INVENTION

Several times during his walks on the moon during Apollo 16, Astronaut John Young was heard to exclaim in exasperation that he wished he could remove the gloves of his spacesuit to complete a task. More than thirty years after the flight of Apollo 16, space suit gloves have advanced very little.

The human hand and wrist contain the majority of the joints in the body, yet the muscles of the hand are some of the weakest in the body. It is the combination of the human mind, sight, reasoning, tactile sense, and the manipulative capacity of the human hand that makes humanity a species capable of controlling its own destiny and manipulating its environment.

In order to provide protection from the space environment, space suit gloves need multiple layers designed to: retain pressurized breathing gas, protect the astronaut's skin from the extreme hot and cold of space, protect the hand and the bladder holding the pressurized breathing gas from rupture due to micrometeorites and the hazards of sharp objects, and provide adequate protection from radiation. The glove's multiple layers inevitably rob the wearer of nearly all tactile sensory input. The pressurization of the suit creates a rigid, difficult-to-bend glove that greatly fatigues the wearer. The effort required to bend the thumb and fingers of a pressurized space suit's glove has been a particular problem, especially for female astronauts.

As humans begin to explore and settle on the lunar surface and the surface of other bodies in space we will need in situ the ability to: assemble and repair equipment using tools, examine collected samples with scientific instruments, operate keyboards to key in data, and use our hands in a multitude of other ways. While the option may exist to take objects into a pressurized spacecraft or space station where they can be worked on in a “shirt sleeve” environment, this inevitably will cause a delay that in some instances may be unacceptable for the safety of the astronaut or the integrity of the science.

### SUMMARY OF THE INVENTION

An embodiment of the present invention provides a sealable and pressurizable enclosure somewhat similar to a conventional glovebox for laboratory use. A conventional glovebox includes inwardly-extending gloves fixed to the glove box and permitting an individual in a human-friendly environment external to the glovebox to manipulate objects in a human-unfriendly environment within the glovebox. Unlike a conventional glovebox, an enclosure in accordance with the present invention does not include gloves, but rather includes one or more ports circumscribed by one or more connectors configured to connect to, and form an airtight seal with, complementary connectors added to a substantially-conventional anthropomorphic pressurizable suit, such as a deep-sea diving suit, or an astronaut's space suit. The enclosure may have a closable and sealable access hatch to permit insertion of objects into the enclosure. After the enclosure is sealed, and the connector(s) of the enclosure are connected to the complementary connectors of the space suit, the enclosure may be pressurized, e.g. to match the internal pressure and gas composition of the astronaut's space suit. The enclosure may have any desired shape and configuration. The individual connectors may be of any suitable design, such as a design similar to that presently or formerly used to connect and seal portions of the space suit.

After pressurization, the astronaut may more comfortably work within the enclosure, even with the entire suit intact; the balancing of pressures internal to and external to the suit reduces fatigue to fingers and other body members caused by the perceived “stiffness” of the suit when such pressures are unbalanced.

Alternatively, any connectors of the suit internal to the enclosure, e.g. a connector attaching a glove near a wrist portion of a suit, may be disconnected to expose a hand or other body member, thus permitting manual work unencumbered by the suit, e.g. to perform fine work with the hands and fingers if a glove has been removed. To avoid contamination of the suit's atmosphere, the enclosure may be maintained at a pressure slightly lower than that of the suit. Optionally, the suit may be modified to include cuffs or an inflatable bladder internal to the suit to form a leak-resistant seal between a body part and the internal portion of the suit. For example, inflatable wrist dams would prevent the gases inside the enclosure from entering the suit while the gloves are off. Thus, for example, the inventive enclosure permits an individual in a human-unfriendly environment external to the enclosure to extend the human-friendly environment of a spacesuit to the environment within the enclosure, and thus to manipulate objects within a human-friendly environment within the enclosure.

An air lock for inserting/removing objects while the enclosure is pressurized may be included. The enclosure may include one or more transparent windows to permit the astronauts to view the contents of the enclosure while the astronaut's space suit is connected thereto. Alternatively, a camera and video display system may be provided.

The enclosure may be configured for use for any desired body part or combination thereof, such as head, foot, leg, or some combination of these that would permit medical treatment of one astronaut by another.

### BRIEF DESCRIPTION OF THE DRAWINGS

The present invention will now be described by way of example with reference to the following drawings in which:

FIG. 1 is an isometric view of an exemplary enclosure in accordance with the present invention;

FIG. 2 is a diagrammatic front view of an exemplary anthropomorphic pressurizable space suit, showing placement of complementary connectors in accordance with the present invention;

FIG. 3 is an isometric view of an exemplary enclosure in accordance with the present invention, showing diagrammatically the enclosure in use by an astronaut wearing a space suit;

FIG. 4 is an isometric view of an enclosure prior to mating with complementary connectors of a space suit;

FIG. 5 is a cross-sectional view of an arm portion of the space suit, taken along line 5-5 of FIG. 4, showing a complementary connector of the space suit; and

FIG. 6 is a cross-sectional view of an arm portion of the space suit, taken along ling 6-6 of FIG. 4, and showing a leak-resistant seal of the space suit.

### DETAILED DESCRIPTION

An embodiment of the present invention provides a sealable and pressurizable enclosure somewhat similar to a conventional glovebox for laboratory use, etc. Exemplary gloveboxes are disclosed in U.S. Pat. Nos. 4,111,753 and 6,428,122, the entire disclosures of which are incorporated herein by reference. Gloveboxes intended for use in a spacecraft are also known. A conventional glovebox includes inwardly-extending gloves fixed to the glove box and permitting an individual in a human-friendly environment external to the glovebox to manipulate objects in a human-unfriendly environment within the glovebox. Unlike a conventional glovebox, an enclosure in accordance with the present invention does not include gloves, but rather includes one or more connectors configured to connect to, and form an airtight seal with, complementary connectors of a space suit, as discussed in greater detail below.

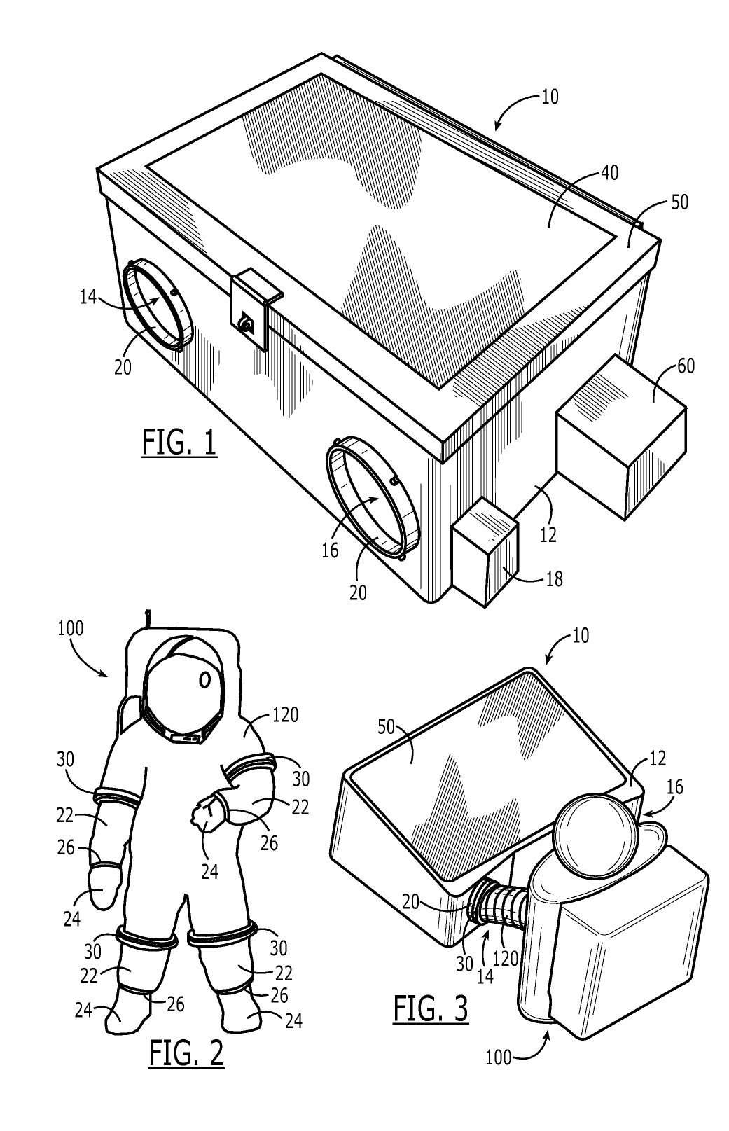

Referring now to FIG. 1, the enclosure 10 comprises a housing 12 having one or more ports 14, 16 through which an astronaut 100 can insert a limb portion, e.g., arm portion, of the space suit into the interior of the housing 12. The housing provides a substantially-closed internal chamber. The housing 12 supports a connector 20 positioned on the housing to circumscribe each port 14, 16. Each connector 20 is configured to connect to, and form an airtight seal with, a complementary connector 30 of a pressurizable suit, such as space suit 120, to close the chamber.

The exemplary housing 12 defines an opening, and further includes a separate access hatch 50 moveable to permit insertion of objects into the enclosure, and to selectively close the opening (as shown in FIGS. 1, 3 and 4) to form an airtight seal with the housing 12. The enclosure may have any desired shape and configuration, and may include any suitable equipment. Preferably, at least a portion of the housing, e.g. a portion 40 of the hatch 50, is visually transparent to permit a person to view operations occurring within the enclosure. Optionally, the housing includes an air-lock 18 communicating with the chamber for admitting objects to and removing objects from the chamber.

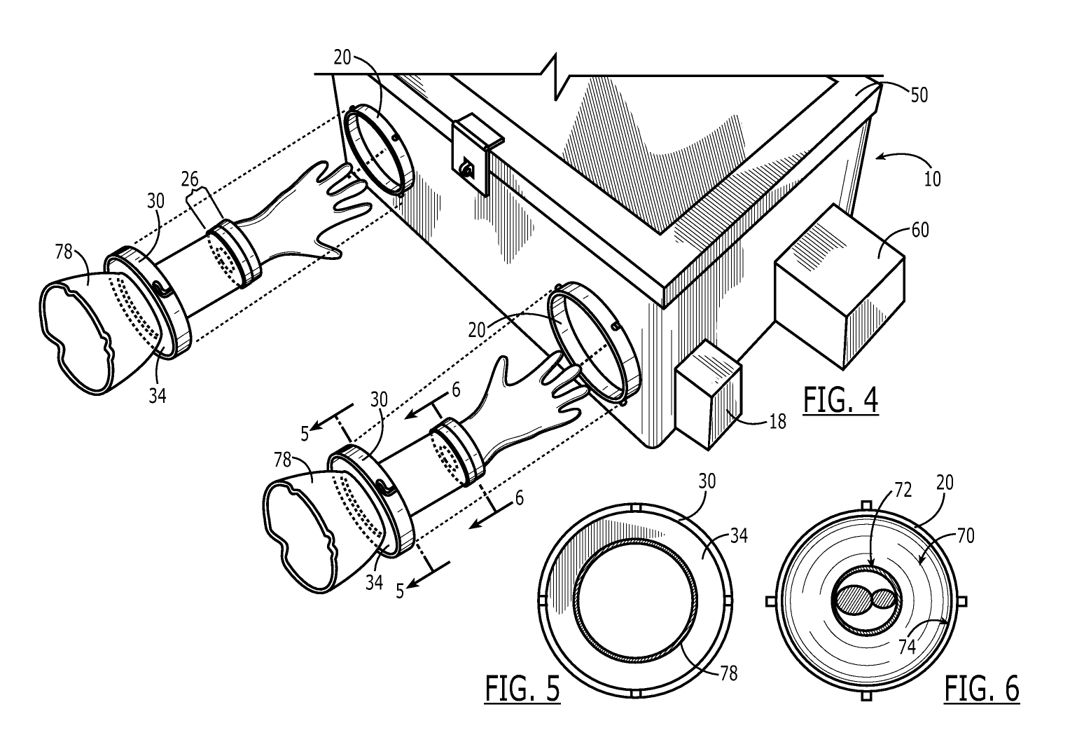

The individual connectors 20, and complementary connectors 30, may be of any suitable design, such as a design similar to that presently or formerly used to connect and seal portions of the space suit, e.g. to connect a glove portion of a space suit to a forearm portion of a space suit. By way of example, complementary connectors of a type disclosed in U.S. Pat. Nos. 3,432,860 or 3,751,727, the entire disclosures of which are hereby incorporated herein by reference, may be used. Unlike conventional connectors, the complementary connector 30 is joined to the suit in a manner circumscribing a portion of the suit, such as a limb portion, and may be modified to have a diameter or other size larger than the suit portion it circumscribes, and larger than any distally located matable decouplable connectors 26, to permit mating with a connector large enough to permit matable decouplable connectors 26 of the suit to pass therethrough, as best shown in FIGS. 4 and 5. Optionally, a portion of the complementary connector 30 may be supported on a flange 34 extending radially away from a periphery of the suit portion 78 it circumscribes, as best shown in FIGS. 4 and 5.

Any limb portion of a suit is inserted into the enclosure only to the point at which the connector 20 on the enclosure 10 contacts and interlocks with a mating complementary connector 30 incorporated into the suit. For this purpose, suitable complementary connectors 30 may be placed on the suit as desired. For example, the suit may include proximal 22 and distal 24 portions joined by mated decouplable connectors 26, and each complementary connector 30 of the suit may be disposed proximally of the mated decouplable connectors 26, as shown in FIG. 2. By way of further example, complementary connectors 30 may be placed on the suit between the wrist and elbow to permit insertion of the hand/wrist, between the elbow and shoulder to permit insertion of the hand, wrist and elbow, between the knee and hip to permit insertion of the lower leg, etc., as shown in FIG. 2 This requires modifying existing suits to provide such complementary connectors 30. Each complementary connector circumscribes a portion of the spacesuit, e.g., encircles a limb, and is positioned to form an airtight connection externally of the space suit.

After all ports of the enclosure have been effectively closed by connecting and sealing corresponding connectors 20 to corresponding complementary connectors 30 of a suit, then the interior of the enclosure can be pressurized, e.g., to match the air pressure and gas composition of the space suit. Once pressurized, the astronaut may remove the portion of the space suit inside the enclosure to the extent permitted by the presence of connectors on the spacesuit, e.g., to remove the gloves. Suitable hardware and technology for performing this function are well-known in the art.

Referring again to FIG. 1, the enclosure may be pressurized by a pressure control system 60 in communication with the chamber. The pressure control system is operable to pressurize (or depressurize, collectively “pressurize”) the chamber to a pressure approximately equal to an internal pressure of a pressurize suit. For example, for an astronaut's space suit, the internal pressure, during normal operating conditions, may be greater than approximately 3.8 psi and less than approximately 7.5 psi. By way of example, the pressure control system may pressurize the chamber by transferring compressed gas from a compressed gas reserve from the space suit via a suitable connection, or from a tank for that purpose incorporated into the enclosure, or from a tank not integral to either the enclosure or an astronaut's space suit. In one embodiment, the reserve of gas used to pressurize the enclosure includes gas having an identical composition to gas used to pressurize the suit. In another embodiment, the reserve of gas used to pressurize the enclosure has a composition different from the composition of gas used to pressurize the suit. This may be useful, for example, to provide a low-oxygen environment within the enclosure for experimental/operational purposes, while maintaining a high-oxygen environment within the suit, for breathing purposes. A depressurization system for safely depressurizing the enclosure may also be included, e.g. as a part of the pressurization system 60. Hardware and techniques for permitting such pressurization are well known in the art and beyond the scope of the present invention.

To prevent contamination of the environment within the suit, e.g. when a dissimilar gas is used to pressurize the enclosure, or when toxic substances may exist within the enclosure, a conventional suit may be modified in accordance with the present invention to include sealing members 70 that resist flow of gas between an astronaut, etc.'s limb 72 and an interior 74 of the suit, e.g. from the chamber of the enclosure into the suit, as best shown in FIG. 6. By way of example, temporarily inflatable bladder or a resilient, e.g. elasticized or elastomeric, cuff adjacent the wrists ankles or other area appropriate to the body part inserted, e.g. proximally of matable decouplable connectors 26 of the suit. Such sealing members abut the limb and provide some protection to the astronaut in the case of an undesirable decompression of the enclosure. Such inflatable pressure dams are particularly useful in cases in which the suit gas composition contains a high partial pressure of oxygen and is therefore highly flammable. In such a case the interior of the enclosure could be pressurized with a gas composition less conducive to supporting a fire.

If systems incorporated into the enclosure require electrical power, it may be supplied either from the power systems of the astronaut's suit via a suitable connection, or from a battery or generator incorporated into the enclosure, or from a separate power system. In the preferred embodiment all such options for providing power to the enclosure are available. Hardware and techniques for permitting such powering the enclosure's systems are well known in the art and beyond the scope of the present invention.

In order to control the pressurization in the case where the suit portions inserted into the enclosure are the arm portions, a control panel may be located in the interior of the enclosure. In other embodiments in which some other portion of the space suit is inserted into the enclosure, e.g., a leg, the control panel may be mounted on the exterior of the enclosure. Some of the functions of these controls in the preferred embodiment are:
1. Control the pressurization of the interior.
2. Control the depressurization of the interior.
3. Engage/disengage the airtight seals.
4. Control interior lights.
5. Operate an attached air lock for moving objects in and out of the enclosure.
6. Control power supplies for tools and instruments located inside or outside the enclosure.
7. Control the recording of voice and/or data.
8. Control transmission of voice and/or data to a remote location.

In order to ensure the safety of an astronaut, an array of sensors along with their associated indicator displays may be installed inside the enclosure. When sensors detect a hazardous condition, a means for notifying the astronaut of that condition should be included. Sensors found in a preferred embodiment may:
1. Measure the temperature of the interior of the enclosure or of specific objects within the enclosure.
2. Measure the pressure within the enclosure.
3. Measure the gas composition within the enclosure.

Such sensors are beyond the scope of the present invention.

In order to prevent exposure to toxic or biological hazards, an air filtration system may be incorporated into the enclosure. An ultraviolet light may be incorporated to create a sterilizing environment within the enclosure or to cause minerals to fluoresce. In order to prevent exposure to toxic fumes the enclosure may maintain a slightly lower than suit pressure. Such filtration systems are beyond the scope of the present invention.

A temperature regulating system may be provided to control the temperature inside the enclosure since many objects in the space environment are dangerously hot or cold. Such systems are beyond the scope of the present invention.

In order to facilitate the removal of the inserted space suit component, e.g., glove, a support may be incorporated into the enclosure to hold, properly orient, and release or connect the space suit component to the rest of the suit. The structure of the support is a function of the structures of the component and the operation of related decouplable connectors, as will be appreciated by those skilled in the art. In the case of an enclosure into which arms are inserted, it may be possible for one hand to don/doff the other glove or suit component inserted; however, it may substantially increase the ease of use of the enclosure if a mechanism to help facilitate this is incorporated into it.

In order to perform various tests, experiments, repairs or operations inside the enclosure a dispenser may be incorporated to dispense water, various reagents, glue, or other needed materials.

The interior of the enclosure may contain a keyboard or other data entry device. The keyboard or other data entry device may operate a computer with output directed to an attached visual display device. There may also be provided one or more storage compartments for storing tools, instruments, or supplies. There may also be provided one or more ports for connecting devices to power, data recording or communication equipment.

The enclosure may be a portable device carried by astronauts with the aid of handles incorporated into the enclosure for that purpose. In an environment with significant gravity, the enclosure may incorporate legs or other elevating means to support it at the proper height for use.

Optionally, the enclosure is configured to mount permanently or temporarily on a vehicle, robot, or the exterior of buildings and spacecraft so that it is readily available when needed. In some instances, equipment to be deployed in the space environment may be enclosed within a dedicated enclosure. A small version that can be mounted on or attached directly to the front of a spacesuit is also feasible.

Multi-user enclosures are feasible and incorporate a means for sealing access ports not being used and to coordinate critical functions such as pressurization and depressurization among the simultaneous users.

Additional examples of embodiments include one or more of the following features:
1. Free-standing, possibly with fold-up/collapsible legs,
2. Mounted on a vehicle,
3. Mounted on robotic assistants,
4. The exterior of buildings and spacecraft,
5. In some instances, equipment, for example, rover driving controls, that require significant manual manipulation may be enclosed within a dedicated enclosure,
6. Emergency medical treatment of hand, foot, leg, or head,
7. Repair or replacement or gloves,
8. Inflatable soft goods implementation for compact stowage, and
9. A small version that can be mounted on the front of a space suit is also be feasible.

In a situation in which a small tear or rupture has occurred in a space suit glove, the astronaut may have time to insert the arms into the enclosure and avoid complete loss of suit pressure. Once in the enclosure a repair or replacement of the space suit glove may be made. The use of the enclosure in such an emergency may provide the extra time for others to effect a rescue of the astronaut.

The enclosure can be designed for manipulating the operating controls of equipment not inside the enclosure. This would be of particular value where many controls are in close proximity or require fine adjustment, and where tactile feedback is an aspect of the control's operation. In such cases, a space suit glove severely restricts the astronaut's proper interaction with the controls. Some examples are:
1. On site remote control operation of science robots,
2. On site remote control of excavation equipment,
3. On site remote control of construction equipment,
4. Direct operation of process equipment, such as a liquefied methane plant on Mars,
5. Direct operation of drilling rigs and other on site resource extraction equipment,
6. Driving controls of an astronaut transport vehicle or construction equipment.

For example, an un-pressurized human transport vehicle could have the driving controls placed inside the enclosure positioned in front of the driver's seat. Using the enclosure to operate the vehicle, the space suited driver will have complete tactile interaction with the vehicle's controls. The space suit environmental control and atmosphere can be provided through the enclosure and the vehicle's stores of expendables rather than from the suit-carried environmental control and expendables. The benefit would be the ability to extend the time operating outside a pressurized habitat.

In some circumstances the enclosure can be used to replace failed space suit systems for power, air, and thermal control.

An enclosure on the same principle could be created that resists external rather than internal pressure and be used with deep sea diving suits.

The enclosure may be used as follows. First, the access hatch 50 may be opened and items to which access is desired from within the enclosure may be placed therein. Next, the access hatch 50 may be closed and sealed, e.g., by engaging latches or the like as generally known in the art of airlocks, etc.

Next, a portion of the space suit may be inserted through a port 14 of the enclosure, and an associated connector 20 of the enclosure may be mated with a complementary connector 30 of the space suit to attach the enclosure to the space suit, and to form an airtight seal therewith. The space suit may have been previously modified to provide such a complementary connector for this purpose. This may be repeated for additional connectors and complementary connectors. At this point, the enclosure has been made airtight.

The enclosure may then be pressurized, e.g. to a pressure matching or complementary to the internal pressure of the space suit. This may be performed by transferring compressed gas from an external gas source to the interior of the enclosure.

Subsequently, any connector connecting portions of the space suit that are positioned within the pressurized enclosure may be disconnected, and a corresponding portion of the space suit, such as a glove, may be removed. In this manner, the astronaut's hand or other body part is exposed within the enclosure, and thus may be used freely. In embodiments in which it is desired to keep separate the respective atmospheres of the enclosure and the space suit, an inflatable cuff within the space suit may be provided adjacent the connector to be disconnected. This cuff may be inflated, before disconnection, to create an airtight seal between an associated body part and an adjacent interior surface of the suit.

Work may then be performed within the enclosure, as desired.

It will be noted that any suitable means may be provided to assist in coupling and decoupling the connectors 20 and complementary connectors 30. In certain embodiments, an the connectors and complementary connectors may engage axially. In other embodiments, the connectors and complementary connectors may engage rotationally. In such an embodiment, the complementary connector 30 may be structurally coupled to the glove, etc. such that twisting of the hand/wrist/forearm/glove causes the rotation of the complementary connector required for coupling or decoupling. In other embodiments, an engagement or release mechanism of a mechanical, electromechanical or other nature may be actuatable by an astronaut, etc. to couple or decouple the connectors, as will be appreciated by those skilled in the art.

After the desired work has been completed, any portion of the space suit that was removed may be reconnected and resealed. After resealing, any inflatable cuff within the space suit may be deflated, as desired.

The enclosure may then be depressurized. After depressurization, the complementary connectors 30 of the space suit may be disengaged from the connectors 20 of the enclosure. The access hatch 50 may then be opened and any workpiece within the enclosure 10 may be removed, if desired.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. An enclosure comprising:
a housing providing a substantially-closed chamber, said housing defining a port providing access to the chamber;
a connector positioned on said housing to circumscribe said port, said connector being configured to mate with, and form an airtight seal with, a complementary connector of a pressurizable suit to close said chamber.

2. The enclosure of claim 1, wherein said housing defines an opening, said housing further comprising a hatch moveable to selectively close said opening and form an airtight seal with said housing.

3. The enclosure of claim 1, wherein said housing further comprises an air-lock communicating with the chamber for admitting objects to and removing objects from the chamber.

4. The enclosure of claim 1, wherein at least a portion of said housing is visually transparent.

5 The enclosure of claim 1, further comprising:
a pressure control system in communication with said chamber, said pressure control system being operable to pressurize said chamber to a pressure approximately equal to an internal pressure of a pressurized suit.

6. The enclosure of claim 5, wherein said pressure is greater than 3.8 and less than 7.5.

7. The enclosure of claim 5, wherein said pressure control system comprises a supply of pressurized gas.

8. The enclosure of claim 7, wherein said supply comprises gas of a type used to pressurize a space suit.

9. The enclosure of claim 7, wherein said supply comprises gas of a type different from that used to pressurize a space suit.

10. The enclosure of claim 7, further comprising a depressurization system operable to depressurize the enclosure.

11. A workspace assembly comprising:
an enclosure comprising:
a housing providing a substantially-closed chamber, said housing defining a port providing access to the chamber; and
a connector positioned on said housing to circumscribe said port, said connector being configured to mate with, and form an airtight seal with, a complementary connector of a pressurizable suit to close said chamber, said port being dimensioned to receive a human limb; and
an anthropomorphic, pressurizable suit configured to provide an airtight environment, said pressurizable suit comprising a complementary connector configured to mate with, and form an airtight seal with, the connector of the pressurizable suit.

12. The workspace assembly of claim 11, wherein said complementary connector is disposed to circumscribe, and to form an airtight seal around, a limb portion of the pressurizable suit.

13. The workspace assembly of claim 11, wherein said pressurizable suit comprises an astronautical space-suit.

14. The workspace assembly of claim 11, wherein said pressurizable suit comprises a deep-sea diving suit.

15. The workspace assembly of claim 11, wherein said pressurizable suit comprises proximal and distal portions joined by mated decouplable connectors, said complementary connector of said pressurizable suit being disposed proximally of said mated decouplable connectors.

16. The workspace assembly of claim 15, wherein said pressurizable suit comprises a sealing member positioned to resist gas flow between a limb and an interior surface of the pressurizable suit.

17. The workspace assembly of claim 16, wherein said sealing member comprises an inflatable bladder expandable to abut the limb.

18. The workspace assembly of claim 16, wherein said seal comprises a resilient cuff abutting the limb.

19. A method for providing a pressure-controlled environment for manual operations, the method comprising:
providing an enclosure comprising:
a housing providing a substantially-closed chamber, said housing defining a port providing access to the chamber;
a connector positioned on said housing to circumscribe the port said connector being configured to mate with, and form an airtight seal with, a complementary connector of a pressurizable suit to close said chamber, said port being dimensioned to receive a human limb; and
a pressure control system capable of varying a pressure within the chamber of the housing;
providing an anthropomorphic, pressurizable suit configured to provide an airtight environment, said pressurizable suit comprising a complementary connector configured to mate with the connector of the pressurizable suit;
connecting the complementary connector of the pressurizable suit to the connector of the enclosure to form an airtight seal therebetween; and
operating the pressure control system to vary the pressure within the chamber of the housing to more closely approximate an internal pressure of the pressurizable suit.

20. The method of claim 19, wherein the pressurizable suit comprises proximal and distal portions joined by mated decouplable connectors, said complementary connector of said pressurizable suit being disposed proximally of said mated decouplable connectors, said method comprising:
extending a portion of the pressurizable suit through the port and into the housing, the portion including the mated decouplable connectors; and
after operating the pressure control system to vary the pressure within the chamber of the housing to more closely approximate an internal pressure of the pressurizable suit, decoupling the mated decouplable connectors to expose human skin within the chamber of the enclosure.

21. The method of claim 20, wherein the pressurizable suit comprises a sealing member positioned to resist gas flow between a limb the skin and an interior surface of the pressurizable suit, the method further comprising:
inflating an inflatable bladder to cause the sealing member to expand to abut the limb.
